(19) United States
(12) Patent Application Publication
(10) Pub. No.: US 2023/0057811 A1
(43) Pub. Date: Feb. 23, 2023

(54) SYNCHRONOUS BELT FABRIC TREATMENT AND BELT

(71) Applicant: GATES CORPORATION, Denver, CO (US)

(72) Inventors: Min Gao, Wuxi (CN); GuoGong Chen, Suzhou City (CN); Carol Weber, Englewood, CO (US)

(21) Appl. No.: 17/890,239

(22) Filed: Aug. 17, 2022

Related U.S. Application Data
(60) Provisional application No. 63/234,370, filed on Aug. 18, 2021.

(51) Int. Cl. F16G 1/16; F16G 1/21; F16G 1/28

(52) U.S. Cl. CPC F16G 1/16; F16G 1/21; F16G 1/28

(57) ABSTRACT

A power transmission belt having a belt body, a tensile cord embedded in the belt body, and a jacket defining a pulley contact surface, where the jacket has been treated on at least the pulley contact surface with an aqueous fabric treatment or dip which includes an aqueous PEEK dispersion as part of the dip. The aqueous dip may further include an epoxy and a rubber latex. The aqueous dip may further include graphene or graphene oxide. The fabric may include aramid or nylon fibers. The jacket may cover the teeth of a toothed belt.

### REFERENCE TO RELATED APPLICATIONS

This application claims the benefits of U.S. Provisional Application No. 63/234,370, filed Aug. 18, 2021, the contents of which are hereby incorporated in their entirety.

Reference is made to application serial number 63/234,369, titled “Synchronous Belt Fabric Treatment and Belt,” filed by the applicant of this application Aug. 18, 2021, the entire contents of which are hereby incorporated herein by reference.

### BACKGROUND OF THE INVENTION

This invention relates generally to a surface treatment for a fiber or yarn used in a tooth fabric or tensile cord embedded in a synchronous belt, more particularly to an adhesion treatment containing polyether ether ketone (“PEEK”).

Synchronous belts (also known as timing belts or toothed belts or positive drive belts) are widely used in power transmission applications requiring accurate timing or synchronization between driven and driver components. Synchronous belts generally have a body of flexible elastomeric material with inextensible tensile members or tensile cords embedded therein. On at least one side of the belt are evenly spaced transverse teeth, designed to mate with grooved sprockets in a drive system. The teeth or toothed surface are generally covered with a tooth covering fabric. The fabric may be treated with an adhesive such as an RFL (resorcinol-formaldehyde-latex), epoxy-latex, or a rubber cement composition for improved adhesion to the belt body and/or for improved surface frictional characteristic, wear resistance, or environmental resistance. Additional, external coatings have also been proposed for changing frictional behavior, wear resistance or environmental resistance. A treated fabric suitable for use as a tooth covering will herein be called a “jacket” to distinguish it from the untreated fabric. Further improvements in adhesion and wear resistance of timing belt fabrics and jackets are desirable.

Toothed belts also generally include an inextensible tensile member which prevents the tooth pitch (i.e., the spacing between teeth or from tooth to tooth) from growing under tensile load. The inextensible tensile members are often twisted cords of fiber glass, carbon fiber, aramid fiber, metal wire, PBO (polybenzobisoxazole), or hybrids thereof. The tensile members are also generally impregnated and/or coated with one or more adhesive treatments for improved adhesion to the belt body. Improvements in tensile member adhesion are also desirable.

PEEK (polyetheretherketone) is a high-performance thermoplastic material. U.S. Pat. Pub. No. 2008/0032837 A1 describes a toothed belt with a modified tooth covering made of polyamide 6,6 having weft threads entirely or partly replaced by yarns of polyether ether ketone (PEEK). U.S Pat. No. 7,705,057 B2 describes PEEK aqueous dispersions.

Improvements in wear resistance and adhesion are useful for synchronous belts and other power transmission belts, including V-belts, V-ribbed belts, flat belts, and so on.

### SUMMARY OF THE INVENTION

The present invention is directed to systems and methods which provide improved textile to rubber adhesion for belt components and/or improved wear resistance for belt jackets.

The invention is directed to an aqueous fabric treatment for a synchronous belt jacket comprising an epoxy, a rubber latex, and an aqueous PEEK dispersion. The PEEK concentration may be in the range of from about 1% to about 5% on a wet weight basis.

The aqueous fabric treatment may further include graphene or graphene oxide at a concentration in the range of from 0.05% to about 6.0% on a dry weight basis

The invention is also directed to a power transmission belt having a belt body, a tensile cord embedded in the belt body, and a jacket defining a pulley contact surface, where the jacket has been treated on at least the pulley contact surface with an aqueous fabric treatment or dip which includes an aqueous PEEK dispersion as part of the dip. The aqueous dip may further include an epoxy and a rubber latex. The aqueous dip may further include graphene or graphene oxide.

The jacket may be a treated fabric comprising aramid or nylon fibers.

The power transmission belt may be in the form of a synchronous belt and therefore have teeth defining the pulley contact surface. Thus, the jacket may cover the belt teeth.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

The accompanying drawings, which are incorporated in and form part of the specification in which like numerals designate like parts, illustrate embodiments of the present invention and together with the description, serve to explain the principles of the invention. In the drawings:

FIG. 1 is a partially fragmented view of asynchronous belt according to an embodiment of the invention;

FIG. 2 is a schematic side view of a peel adhesion test;

FIG. 3 is a schematic perspective view of a drill press wear test; and

FIG. 4 is a schematic of a hot oil test for belts.

### DETAILED DESCRIPTION

The invention relates to a fabric treatment with some PEEK aqueous dispersion content. The PEEK treatment may be applied to a fabric, which may have other treatments already on it. The resulting jacket may be used as a tooth cover jacket on a synchronous belt, or as a pulley contact surface on other kinds of power transmission belts.

PolyEtherEtherKetone or “PEEK” is a high-performance thermoplastic material and a member of the polyaryletherketone polymers. It has conventionally been obtained in the form of semi-crystalline granules for injection molding and extruding plastic articles, alternately with various reinforcing fillers. The chemical formula of PEEK is:

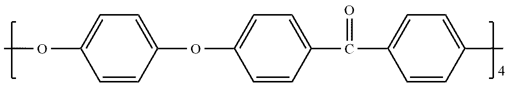

PEEK is known to have exceptional scratch and wear resistance, a low coefficient of friction (“COF”), a wide range of temperature performance (-150° C. to about +250° C.), very good oil/solvent/chemical resistance, and excellent physical properties. Here, for the first time, we use water-based PEEK dispersions to improve the wear resistance of treated fabrics. The PEEK dispersions may be those sold under the Vicote trademark by Victrex plc. Other types of aryletherketone polymers would probably be suitable in the practice of this invention if available in aqueous dispersion form.

The preferred fabric treatments for use in this invention are aqueous treatments, such as resorcinol-formaldehyde-latex (“RFL”) treatments, epoxy dispersions, epoxy-latex treatments, and the like. RFL adhesives are well-known to those of skill in the art and will not therefore be described in detail here. A preferred treatment is an epoxy-latex-PEEK formulation. Other ingredients may be included in the treatment, including carbon black or dyes, hardeners or curatives, antioxidants, surfactants, or other solvents.

An exemplary epoxy-latex treatment is described in U.S. Pat. Pub. No. 2014/0080647 A1, published Mar. 20, 2014, hereby incorporated herein by reference. That publication discloses a toothed belt with a belt body that includes teeth on one surface side thereof, and a facing fabric which has been treated with a hardened material of a first epoxy resin. Alternately, the facing fabric is treated with a treatment agent composition including a second epoxy resin, a second hardener for hardening the second epoxy resin, and a rubber component. According to embodiments of this invention, PEEK may be added to such epoxy or epoxy-rubber fabric treatments and coated on the fibers of a fabric to improve adhesion of the fabric to rubber belt bodies and/or to improve wear resistance of the fabric.

The fabrics may be any fabric used as a belt cover or rubber reinforcement, but particularly preferred are nylon 6,6 fabrics, aramid fabrics, and blends of the two. The aramid fibers may include para-aramid, meta-aramid or co-polymeric aramid fibers. the fabrics may be woven, non-woven or knit. The yarns may include elastic thread for improved stretchability of the aramid yarns. The yarns may be wrapped yarns.

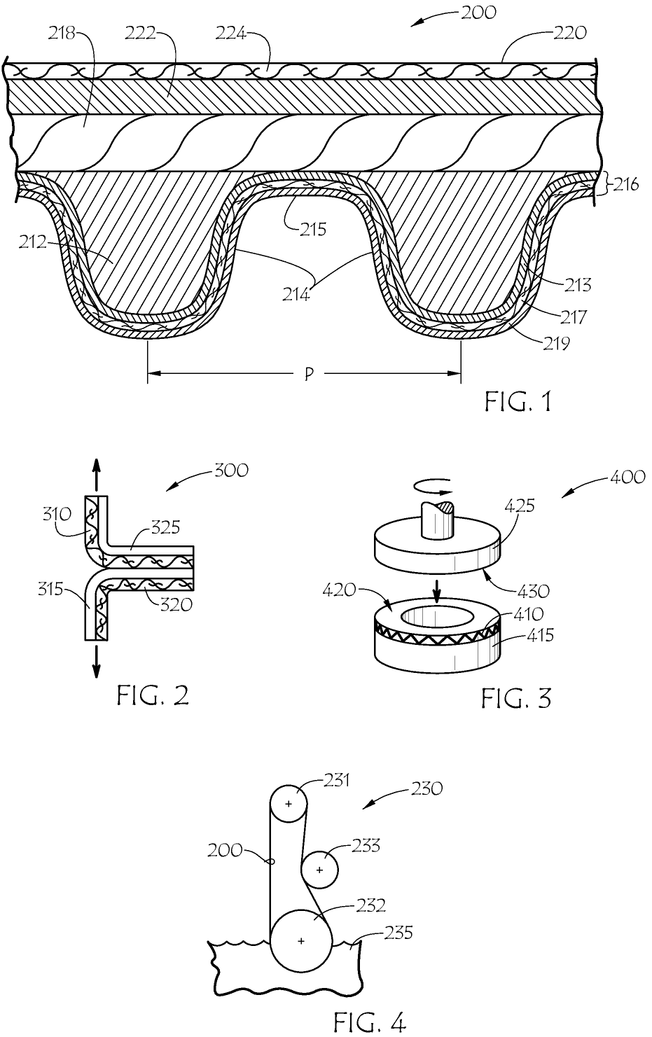

The construction of a timing belt according to the invention is illustrated in FIG. 1. It should be understood that only a portion of the endless belt is shown in FIG. 1. Belt 200 includes teeth 214 on one side, which engage grooved sprockets or grooved pulleys. The teeth 214 alternate with lands 215. The curved transition from the flank of tooth 214 to land 215 is called the root or the tooth root. The belt 200 has a smooth back side 220, although an alternate embodiment may have similar teeth on both sides. The body rubber or elastomer includes tooth rubber 212 and back rubber 222. The toothed side is covered with tooth jacket 216 and the back side 220 is covered with back jacket 224. The tooth repeat length is called the pitch, “P.” The tensile member 218 is embedded in the belt body rubber and gives the belt its high modulus in tension. The tensile member 218 may include one or more adhesive treatments which may include graphene or graphene.

The tooth jacket 216 includes a fabric 217, surface treatment 219, and one or more additional fabric treatments, such as adhesion layer 213, to enhance one or more belt properties, for example, adhesion, oil resistance, wear resistance, and the like, as well as system performance properties such as timing error and durability. One or more of the fiber treatments may comprise graphene or graphene. Likewise, the back jacket 224 may include a fabric and one or more of the same or different treatments as the tooth jacket. The term “jacket” is thus used to describe a fabric with one or more treatments included which is generally the form in which it is ready for assembly into the belt or other rubber composite article. “Fabric” generally refers to the greige woven, non-woven, or knit material before applying treatments. The outer surface treatment 219 comprises PEEK obtained from an aqueous PEEK dispersion which is added to the other ingredients in the outer surface treatment.

Adhesion may be tested with a peel adhesion test. FIG. 2 illustrates the peel adhesion test used herein. The test specimen 300 includes at least two layers of rubber and two layers of the test fabric or jacket. The interface between jacket 310 and test rubber layer 315 is separated by pulling as indicated by the arrows. Jacket layer 320 stabilizes the test rubber layer 315 and rubber layer 325 stabilizes jacket 310 and facilitates gripping.

The wear resistance can be tested in the lab with a Drill Press Wear Test. FIG. 3 illustrates the Drill Press Test 400 as used herein. In this test, the jacket is cut into a 1.1-inch (28 mm OD) circle with a 0.75-inch (19 mm ID) hole. The resulting jacket ring 410 is vulcanized to a rubber substrate 415. The jacket contact surface 420 is abraded by the counterface 430 of a rotating aluminum disk 425, rotating at approximately 200 rpm under a contact force of 7 kg for 72 hours. The resulting weight loss is indicative of the wear resistance of the jacket under dry conditions and the amount of debris generated by the sample.

Wear resistance and adhesion can also be tested on belt drives. A hot oil belt test (“HOL”) was used herein to evaluate belt performance of the coatings. The hot oil tester was run at 140° C. and 18 kW load and 6200 rpm. The drive layout 230 of the HOL tester is illustrated in FIG. 4. The driven pulley is approximately half-submerged in a bath 235 of Castrol motor oil. Pulley 231 is the driver with 20 grooves and pulley 232 is the driven sprocket with 40 grooves, both with RPX-profile grooves. The idler 233 has an outside diameter of 61 mm. The belt 200 tested is always 10-mm wide and has 85 teeth with 9.525-mm pitch and RPP tooth profile. The installation tension is 160 N.

### Examples

The examples that follow illustrate the use of PEEK in various coatings for various belt cover fabrics to improve adhesion and/or wear resistance. Comparative examples are indicated as “Comp. Ex.” and inventive belt examples as “Ex.”

A first set of examples starts with an epoxy-latex treatment as described in US 2014/0080647 A1. The epoxy-latex coating was modified to include graphene, which was then used as the control for the experiments and as the base coating and identified as Control 1 Dip in TABLE 1. Dips A - D in TABLE 1 include PEEK. The PEEK used was Vicote F804 in Dips A and B and Vicote F807BLK in Dips C and D. Dips B and D have 5 times as much PEEK as dips A and C. The graphene used was GP1201, from The Sixth Element(Changzhou) Materials Technology Co., Ltd. GP1201 is a 5%-solids, water-based dispersion, with pH of 7-8, and viscosity of ≤3000 mPa.s, having an average particle size of ≤6 µm (D50).

The dips were applied onto two fabrics. One was a modified-plain-woven fabric having a mixture of aramid and nylon fibers in both the warp and the weft (indicated “aramid/nylon blend” in TABLE 2). The other was a twill woven fabric having para-aramid yarns and elastic yarn in the weft and meta-aramid yarn in the warp (indicated “aramid only fabric” in TABLE 2).

Timing belt fabrics such as those used in these experiments tend to have a rougher side and a smoother side. The rougher side is intended for bonding to the belt body, hopefully with better mechanical adhesion due to the roughness. The smoother side is intended for a pulley contact surface. The results herein are generally concerned with the smoother side, unless otherwise indicated.

Three methods were used to apply the dips. In a first dipping process, both fabrics were dipped in the Control 1 Dip formulation for one minute, dried in air for 20 to 30 minutes, then baked in an oven for 20 minutes at 155° C. The dip pickup was 15-20% by weight for the aramid/nylon blend and 21-25% for the aramid only fabric. This was the base fabric for what follows. The second method included a spraying process. Additional Control 1 Dip was sprayed onto the smooth side of the control examples for Comp. Ex. 1. Dip A was sprayed onto both base fabrics for Ex. 2. Dips B, C, and D were applied to the base fabrics by a third method, brushing on with a foam applicator. The final coated fabric was baked in an oven for 20 minutes at 120° C. The total pickup weight was in the range of 24-39% for the aramid/nylon blend jackets and in the range of 36-53% for the aramid only jackets. Peel adhesion to an HNBR, adhesive-rubber formulation was tested. The adhesive rubber is one used as a rubber cement for timing belts. All compositions are in weight per cent unless otherwise noted.

TABLE 2 shows that the peel adhesion for the Examples exceeds the Comp. Ex. 1, except for one sample that was basically equivalent. Thus, the PEEK generally can improve adhesion in these formulations, but it is at least not detrimental to adhesion. The aramid jackets were tested on the Drill Press Wear Test. The abrasion weight loss is significantly less for the Examples with PEEK in the fabric coating, especially Ex. 3. It may also be noted that the Drill Press weight loss for the same fabric with a dip the same as Control 1 Dip, but with no graphene was 0.141 g. So the addition of graphene improves the wear resistance of Comp. Ex. 1 by about 15%. That is why these examples chosen to show the advantages of PEEK also include graphene. The related application mentioned above suggests that graphene or graphene oxide at a concentration in the range of from 0.05% to about 6.0% on a dry weight basis may be advantageous in the inventive formulations.

Table 1

| | | Control 1 Dip | | Dip A | | Dip B | | Dip C | | Dip D | |
|---|---|---|---|---|---|---|---|---|---|---|---|
| Ingredient | Solid content (%) | Wet Wt. (g) | Dry Wt. (g) | Wet Wt. (g) | Dry Wt. (g) | Wet Wt. (g) | Dry Wt. (g) | Wet Wt. (g) | Dry Wt. (g) | Wet Wt. (g) | Dry Wt. (g) |
| Water | 0 | 407 | 0 | 424 | 0 | 515 | 0 | 424 | 0 | 515 | 0 |
| Epoxy resin | 100 | 70 | 70 | 70 | 70 | 70 | 70 | 70 | 70 | 70 | 70 |
| NBR Latex | 41 | 73.2 | 30 | 73.2 | 30 | 73.2 | 30 | 73.2 | 30 | 73.2 | 30 |
| Curing agent | 100 | 3.5 | 3.5 | 3.5 | 3.5 | 3.5 | 3.5 | 3.5 | 3.5 | 3.5 | 3.5 |
| Graphene | 8 | 36.9 | 2.96 | 39.2 | 3.14 | 51.5 | 4.12 | 39.2 | 3.14 | 51.6 | 4.13 |
| PEEK F804 | 37.4 | | | 16.7 | 6.3 | 110. | 41.2 | | | | |
| PEEK F807BLK | 36.7 | | | | | | | 17.1 | 6.3 | 112.6 | 41.3 |
| Total Weight | | 591 | 106 | 627 | 113 | 823 | 149 | 627 | 113 | 826 | 149 |
| % PEEK (Wt. %) | | 0 | 0 | 1.0 | 5.5 | 5.0 | 27.7 | 1.0 | 5.5 | 5.0 | 27.7 |

Table 2

| | | | | | |
|---|---|---|---|---|---|
| Test results on fabrics | Comp. Ex. 1 | Ex. 2 | Ex. 3 | Ex. 4 | Ex. 5 |
| Smooth-side coating Applied | Control 1 Dip | Dip A | Dip B | Dip C | Dip D |
| Aramid/nylon blend fabric Peel adhesion results (N/25mm) | 111 | 153 | 108 | 129 | 138 |
| % improvement | | 38% | -3% | 16% | 24% |
| Aramid only fabric Peel adhesion results (N/25mm) | 136 | 207 | 195 | 231 | 215 |
| % improvement | | 52% | 43% | 70% | 58% |
| Drill Press Wear test (weight loss (g)) | 0.120 | 0.109 | 0.093 | 0.100 | 0.105 |
| % improvement | | 10% | 23% | 16% | 13% |
| HOL test belt life (hours) | | | | | |

In a second series of experiments, a slightly different base dip was used, identified in TABLE 3 as Control 2 Dip. This one had a little less graphene and some additional carbon black. Based on the first series results, 5% PEEK (wet basis) from Vicote F804 was added to make Dip E, and 1% PEEK (wet basis) from Vicote F807BLK was added to make Dip F. The Control 2 Dip was applied to the aramid only fabric as above to make a base fabric for further treatments. The base fabric, Comp. Ex. 6, had a dip pickup of 34%. TABLE 3 shows the formulations for this series. Some fabric examples were made for adhesion testing and are listed in TABLE 4. The fabric was the aramid stretch fabric described above. The fabric was first dipped in Control Dip 2 for use as Comp. Ex. 6. Comp. Ex. 6 was then further coated onto the smooth side with Dip E or Dip F to make Ex. 7, Ex. 8, and Ex. 9. Ex. 8 was coated multiple times until the coated fabric appeared smooth, at a 53% dry weight pickup.

The rubber used for the adhesion test was the HNBR-based adhesion rubber formulation described previously. The adhesion results reported in TABLE 4 do not indicate significant improvement in adhesion, but they do indicate satisfactory adhesion. These jackets were made into belts and tested on the HOL test. They all ran a similar number of hours (these tests can be highly variable), however the Ex. 7 belt appears to be quite a bit better than the others. However, it may be noted that these belts were not well-optimized for pitch fit on the test drive. Nevertheless, the Ex. 7-9 belts at the end of the test indicated an improvement in observed wear compared to Comp. Ex. 6. In particular, the Comp. Ex. 6 belt showed severe land wear and tooth flank wear, while the inventive belts or Ex. 7-9 tended to have other issues, such as tensile cord pullout, frayed edges, or tooth shear.

Table 3

| | | Control 2 Dip | | Dip E | | Dip F | |
|---|---|---|---|---|---|---|---|
| Ingredient | Solid content (%) | Wet Wt. (g) | Dry Wt. (g) | Wet Wt. (g) | Dry Wt. (g) | Wet Wt. (g) | Dry Wt. (g) |
| Water | 0 | 422 | 0 | 542 | 0 | 440 | 0 |
| Epoxy resin | 100 | 70 | 70 | 70 | 70 | 70 | 70 |
| NBR Latex | 41 | 73.2 | 30 | 73.2 | 30 | 73.2 | 30 |
| Curing agent | 100 | 3.5 | 3.5 | 3.5 | 3.5 | 3.5 | 3.5 |
| Carbon Black | 35 | 8.6 | 3.1 | 12.2 | 4.3 | 9.2 | 3.2 |
| Graphene | 8 | 23 | 1.84 | 32 | 2.56 | 24 | 1.92 |
| Vicote F804 PEEK | 37.4 | | | 114 | 42.6 | | |
| Vicote F807BLK | 36.7 | | | | | 17.5 | 6.4 |
| Total Weight | | 600 | 108.4 | 847 | 153 | 637 | 115 |
| % PEEK (Wt. %) | | 0 | 0 | 5.0 | 27.9 | 1.0 | 5.6 |

Table 4

| Test results on fabrics | Comp. Ex. 6 | Ex. 7 | Ex. 8 | Ex. 9 |
|---|---|---|---|---|
| Coating applied¹ | Control 2 Dip | E | E | F |
| Coating pickup (% by wt.) | 34% | +22% | +53% | +20% |
| Aramid fabric Peel adhesion-coated side (N/25mm) | 174 | 134 | | 149 |
| Aramid fabric Peel adhesion-uncoated side (N/25mm) | 158 | 121 | 95 | 118 |
| HOL test belt life (hours) | 60 | 115 | 19 | 42 |

¹ Control 2 Dip was applied to all examples by dipping. Dips E and F were then applied to the smooth, external side by foam applicator.

Improvements in both the Drill Press Wear Test and the HOL belt test indicate the inventive jackets may have usefulness both in dry belt drive applications and oil-wet drives.

Although the present invention and its advantages have been described in detail, it should be understood that various changes, substitutions, and alterations can be made herein without departing from the scope of the invention as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps. The invention disclosed herein may suitably be practiced in the absence of any element that is not specifically disclosed herein.

What is claimed is:

1. A power transmission belt comprising a belt body, a tensile cord embedded in the belt body, and a jacket defining a pulley contact surface; the jacket having been treated on at least the pulley contact surface with an aqueous dip comprising a dispersion of polyetheretherketone (“PEEK”) and dried.

2. The power transmission belt of claim 1, wherein the aqueous dip further comprises epoxy and a latex.

3. The power transmission belt of claim 2, wherein the aqueous dip further comprises graphene or graphene oxide.

4. The power transmission belt of claim 1, wherein the concentration of the PEEK in the aqueous dip is in the range of 1% to 5% on a wet weight basis.

5. The power transmission belt of claim 1, wherein the jacket comprises a fabric comprising aramid fibers.

6. The power transmission belt of claim 1, wherein the jacket comprises a fabric comprising nylon fibers.

7. The power transmission belt of claim 1 in the form of a synchronous belt and further comprising teeth defining the pulley contact surface.

8. A power transmission belt comprising a belt body, a tensile cord embedded in the belt body, and a jacket defining a pulley contact surface; the jacket having been treated on at least the pulley contact surface with an aqueous dip comprising a dispersion of polyetheretherketone (“PEEK”), an epoxy, and a rubber latex and dried; the jacket comprising a fabric comprising an aramid yarn.

9. The power transmission belt of claim 8 in the form of a synchronous belt and further comprising teeth defining the pulley contact surface.

10. An aqueous fabric treatment for a synchronous belt jacket comprising:
an epoxy;
a rubber latex; and
an aqueous PEEK dispersion;
wherein the PEEK concentration is in the range of from about 1% to about 5% on a wet weight basis.

11. An aqueous fabric treatment of claim 10 further comprising graphene or graphene oxide at a concentration in the range of from 0.05% to about 6.0% on a dry weight basis.
